(19) United States
(12) Patent Application Publication
(10) Pub. No.: US 2026/0119130 A1
(43) Pub. Date: Apr. 30, 2026

(54) SIMPLIFYING IOT DEPLOYMENT THROUGH GENERATIVE AI AND MACHINE LEARNING

(71) Applicant: HEWLETT PACKARD ENTERPRISE DEVELOPMENT LP, Spring, TX (US)

(72) Inventors: ARJUN LOGANATHAN, Spring, TX (US); Ankur Kamthe, Santa Clara, CA (US); Mohd Shahnawaz Siraj, San Jose, CA (US)

(21) Appl. No.: 18/930,057

(22) Filed: Oct. 29, 2024

(51) Int. Cl. G06F 8/34; G06F 40/284

(52) U.S. Cl. CPC G06F 8/34; G06F 40/284

(57) ABSTRACT

Systems and methods are provided for recommending applications and generating application code. An application store may maintain existing applications used, e.g., for classifying Internet of Things (IoT) devices. Based on characteristics of the IoT devices and existing applications, one or more applications can be recommended to a user for classifying unclassified IoT devices in a deployment. Once classified, the user can engage in a question and answer session with a chatbot resulting in the generation of application code for performing at least one of edge compute and data transport operations involving the classified IoT devices.

### BACKGROUND

Many modern devices such as, for example, heat sensors, smart light bulbs, smart kitchen devices, printers, cameras, and other smart devices are embedded with a computing system that enables these smart devices to connect and exchange data over the internet. These smart devices are commonly referred to as Internet-of-Things (IoT) devices.

Along with the prevalence of IoT devices, comes the burden of managing IoT devices. This is especially important in the enterprise context, where users often manage enterprise IoT devices at the edge of their system or network.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example network management architecture in which an IoT operations function is implemented to manage and control an IoT deployment in accordance with examples of the disclosed technology.

FIG. 2A is an example schematic representation of a IoT operations system including an application store and application development portal in accordance with examples of the disclosed technology.

FIG. 2B illustrates an example question and answer session and automatically generated code as a result of the question and answer session.

FIG. 3 illustrates components and workflow associated with chatbot auto-generated code in accordance with examples of the disclosed technology.

FIG. 4 is a computing component configured to effectuate automatic code generation pursuant to chatbot-generated question and answer sessions with a user regarding the user's IoT device deployment.

FIG. 5 is a computing component that may be used to implement examples of the disclosed technology.

The figures are not exhaustive and do not limit the present disclosure to the precise form disclosed.

### DETAILED DESCRIPTION

As noted above, management of IoT devices in an IoT deployment, e.g., an enterprise IoT deployment, is an important task. To ease the burden of IoT deployment management, examples of the disclosed technology provide systems and methods that leverage artificial intelligence (AI)/machine learning (ML) to enable computerized management, connectivity, and visibility of non-Wi-Fi devices, such as IoT devices in the form of an IoT operations system or function.

In particular, a cloud-based application store and application development portal (ADP) can be made available on a network management system. The network management system may comprise a cloud-based network management system that can act as a single point of control that an entity (a user or enterprise) may use to oversee aspects of wired/wireless networks (local area networks (LANs), wide area networks (WANs), virtualized private networks (VPNs)) across local, branch, or remote sites.

The cloud-based application store can provide various tools or applications that users can rely on to manage or control their IoT deployment. An example of an application may be an IoT application that comprises a collection of separate components that provide edge compute/computing capabilities. The collection of separate components are typically specific to a user's (e.g., network operator entity's) requirements, and can include a Lua script for device classification, application-specific metadata, and containers for the edge compute capabilities.

While the aforementioned ADP can be used to allow users to develop their own applications that can be uploaded to the application store, users are likely to be unfamiliar and un-versed with application store-provided application programming interfaces (APIs). Lua scripts refer to pieces of code written in the Lua programming language, a lightweight and high-level, multi-paradigm programming language designed primarily for web application development, developer tool creation, and the like. Although Lua is a lightweight and high-level language, users will also likely be unfamiliar with its usage, not to mention the workflow associated with uploading apps to the application store. It should be noted that Lua is one example of a language that can be used, but examples of the disclosed technology may rely on other languages that users may still not necessarily be familiar with.

Such a workflow, without leveraging AI/ML as disclosed herein, might otherwise involve creating an IoT device classification application based on Lua script, and the use of one or more APIs provided by the IoT operations system. The user might then upload the IoT device classification application to the ADP in conjunction with application-specific metadata that allows network infrastructure to run the IoT device classification application with proper input data. Such input data in this context can be, e.g., the bytes comprising advertisement and scan response packets that are broadcast by the IoT devices. Additionally, still, an application container could be uploaded to the ADP to allow for further processing of output data from the IoT device classification application (Lua script) using custom business logic, i.e., the set of conditions or checks used so that the Lua script can match the contents of the packet payload. An example of this matching may be correlating a Bluetooth® Special Interest Group (SIG) company identifier to one present in manufacturer-specific advertising data element in a Bluetooth® Low Energy (BLE) packet payload.

In order to leverage AI/ML, examples of the disclosed technology may first, collect a user's IoT device information (e.g., device type(s), class(es), device vendor info for already-classified customer device(s)), and existing application information from the application store. IoT deployments can often comprise IoT devices from many different vendors, resulting in high IoT device heterogeneity. Classification applications for classifying the customer's devices may be provided in the application store. It should be understood that typically, a user must create a device classification application to identify their devices of interest, e.g., the IoT devices of their IoT deployment.

Second, examples of the disclosed technology may provide a chatbot that leverages a natural language toolkit (NLTK), a pre-trained large language model (LLM), and code-generation functionality, in order to create a question and answer (Q and A) code generation interface. LLMs, such as Llama2 can provide code-generation functionality for users.

The chatbot can be trained using existing application store applications, default Lua script examples, and application store user documentation. In particular, the NLTK parses user inputs, and identifies keywords (vendor identifiers, device classes, service data, and device-specific context). Training data is ingested and parsed, and the training data can be stored in a vector store database, and used to create a Q and A chain powered by the LLM. Any resulting code/script can be uploaded to the ADP (after validation), where any metadata is populated using application store APIs. It should be noted that a Q and A session is not mandatory. If a user can provide the requisite information without a Q and A interaction with the chatbot, the application code can still be automatically generated.

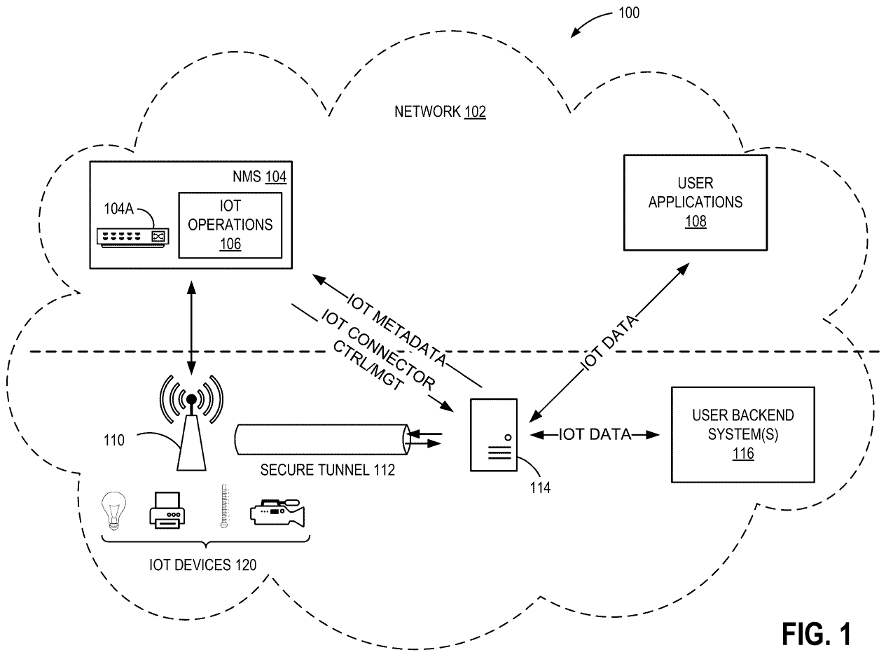

FIG. 1 illustrates an example, cloud-based IoT management architecture 100. The architecture 100 includes a cloud-based network management system (NMS) 104 that operates over a network 102. Network 102 can include, for example, any one or more of a personal area network (PAN), a local area network (LAN), a campus area network (CAN), a metropolitan area network (MAN), a wide area network (WAN), a broadband network (BBN), the Internet, and the like. Further, network 102 can include, but is not limited to, any one or more of the following network topologies, including a bus network, a star network, a ring network, a mesh network, a star-bus network, tree or hierarchical network, and the like.

Network management system 104 may comprise, in part, one or more servers 104A that monitors the health and performance of network 102, and/or configures devices connected thereto, such as access point (AP) 110, and IoT devices 120. One or more servers 104A can be a cloud computing server of an infrastructure-as-a-service (IaaS), and able to support a platform-as-a-service (PaaS) and software-as-a-service (SaaS) services. Examples of IoT devices 120, may be a smart light bulb, a printer, a smart thermometer or kitchen device, or a video camera, heat sensors, or any other devices having appropriate embedded processor, memory, and communications capabilities. IoT devices typically comprise one or more sensors, microcontrollers, and network connectivity functionality. Sensors can be used to collect information about the physical environment in which an IoT device is deployed. Microcontrollers can provide computing power, memory, and can facilitate Internet connectivity for the IoT device. Network connectivity is used to move data to/from the IoT device. Various communications technologies may be appropriate depending on the type of IoT device at issue, as well as the environment in which an IoT device is deployed.

NMS 104 may host or support IoT operations by way of an IoT operations system or function 106. NMS 104 may support the transporting of IoT data over, e.g., a user's (enterprise's) WLAN. AP 110 can receive data from IoT devices 120. AP 110 can send dashboard metadata to NMS 104. AP 110 can also send IoT data to external servers or other devices, such as a user backend system(s) 116, through one or more IoT connectors, such as IoT connector 114. NMS 104 may provide IoT connector control, management, and dashboard visibility, where a dashboard can be used to provide a view of the IoT connectors, IoT devices, and any installed applications.

IoT connector 114 may aggregate IoT device data, perform edge compute, and run business logic on raw data, for example, before sending the aforementioned dashboard metadata and IoT data. Applications developed by a user, such as user applications 108, can also be used to send IoT data to external servers or devices, and can be made available on an application store (as will be discussed in greater detail below). It should be understood that an IoT connector can refer to an application that runs on a data collector platform (not shown) that processes network data, and can be made available as both a physical appliance, or it may be run as a virtual appliance. An IoT connector, such as IoT connector 114, can receive the IoT data from APs, such as AP 110 by way of a secure tunnel, e.g., secure tunnel 112.

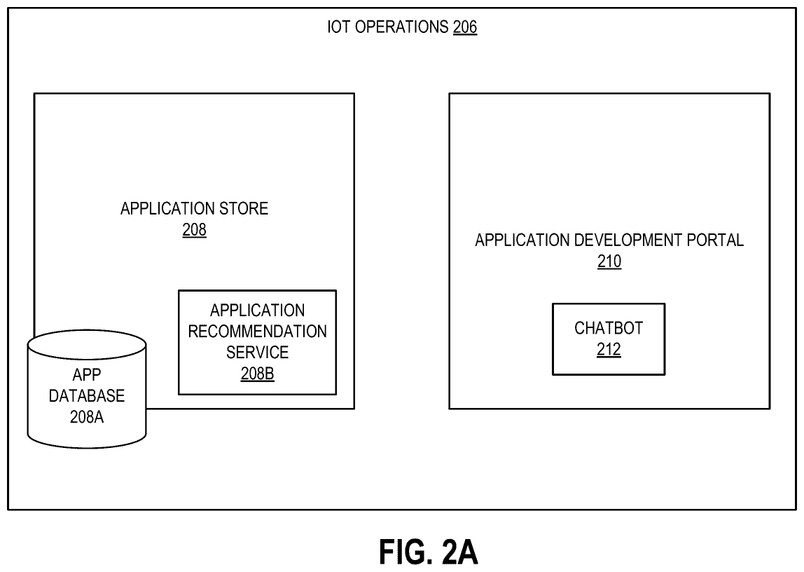

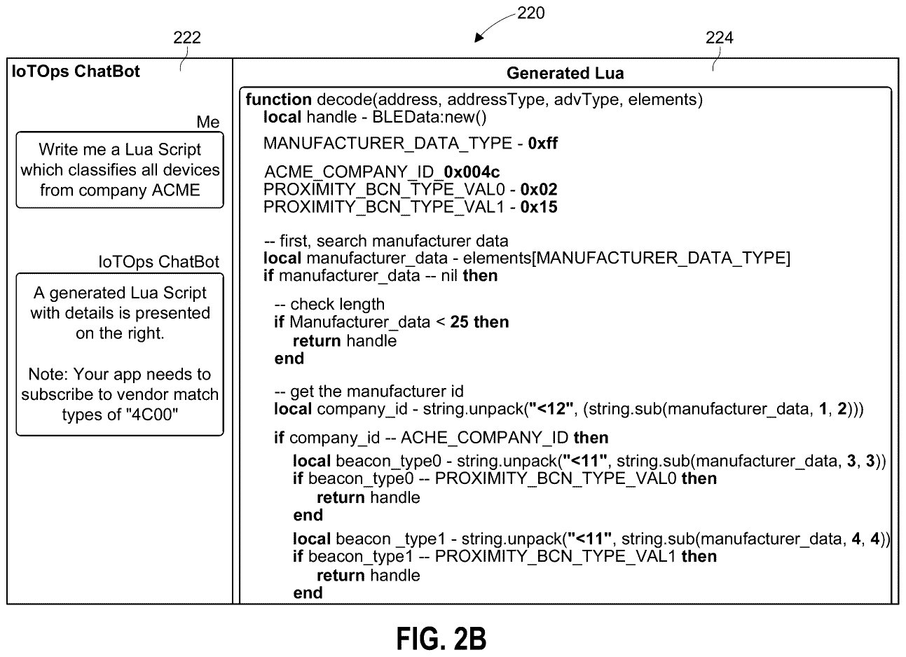

FIG. 2A is an example schematic representation of an IoT operations system 206, which may be an embodiment of IoT operations system/function 106 of FIG. 1. As noted above, IoT operations system 206 may comprise an application store, e.g., application store 208. Application store 208 may be embodied as an application repository for existing IoT applications that an enterprise may use for their end-to-end workflows. IoT applications may be stored in an application database 208A associated with application store 208.

An IoT application can refer to a user-developed, customized edge compute unit that can be deployed in an IoT network infrastructure. Such IoT applications can be deployed on and run in an IoT connector, an example of which is IoT connector 214 of FIG. 2A. As noted above, an IoT application may be a collection of components that together facilitate or provide the ability to perform edge computing (a distributed computing framework that moves computing and data storage closer to the devices, in this case, IoT devices, that produce the data, as well as other devices that consume the data).

Typical IoT applications can include device classification applications, device data processing applications, and data transport applications. For example, using Lua scrips, an IoT device can be assigned a device class (BLE, Zigbee, and Universal Serial Bus (USB) devices). A device classification application may identify an IoT device, set its respective device class attribute, and parse any device attributes (e.g., sensor information) also using a Lua script. After a device class is set, the device classification application can perform filtering on subsequently received data packets received from that IoT device for further processing or data transport.

In terms of device data processing, IoT applications can facilitate data aggregation, data enrichment, or business logic that can work with IoT device data. APIs for configuration and management of IoT device can also be implemented via a device data processing application.

Data transport IoT applications can be developed for configuring secure connections to a user's business application server(s). Such data transport applications may also perform data normalization or format conversions. Users may also develop and implement user-specific or vendor-specific data transport protocols.

Common IoT application use cases can include, but are not limited to IoT device classification, as described above, device management, e.g., Zigbee device management, a combination of device classification, edge compute, and data transport, AP beacon management, IoT radio firmware management, etc. For example, a BLE IoT device classification application may be used in conjunction with, e.g., a data transport application to have an end-to-end data flow from IoT devices to a user's business application.

In some examples, an IoT application may comprise metadata, decoder Lua script (e.g., in the case of IoT devices that communicate using BLE), serial data framing Lua script, and a docker container. The metadata may include, but is not necessarily limited to: application and author information; an application icon; application configurations and capabilities; resource requirements; application API permissions; and application subscriptions. The decoder Lua script may enable the IoT application to parse, e.g., BLE frames, and set device properties in an IoT device database (not shown). The serial data framing Lua script can be used when serial data is to be processed to/from USB devices. The docker container (a lightweight executable software package that can run an application) can be used to implement edge compute code, set up connections to a user's/enterprise's business application, and implement the application itself, along with any enterprise or user APIs. An example of a custom business application may be a Universal Seral Bus (USB) Lua script that gathers and formats bytes received over a serial port from a specific USB device of interest. The corresponding container can execute the custom business application logic for further parsing the bytes from the USB device's data packets into attributes such as environmental sensor data, which can, in turn, be forwarded to the application service provider's cloud backend for display to a customer.

As noted above, an AP can receive data from IoT devices, and an AP can also send IoT data to external servers or other devices, such as a user backend system(s) through one or more IoT connectors. Against this backdrop, an IoT application developer would define and configure the following aspects on the IoT connector. In the case of BLE-capable IoT devices, for example, a BLE decoder service or engine that runs Lua scripts defined in the IoT application would be defined/configured, along with a subscription service that distributes IoT device payload data for transport to the BLE decoder, or to a partner API. For example, an IoT application can subscribe to data streams from particular IoT devices based on filters, such as a vendor filter, a UUID, local name, and device class. Furthermore, a developer would configure and define an application container, e.g., a docker container that maintains the IoT application in container sandbox, where the IoT application will primarily interact with user APIs, e.g., REpresentational State Transfer (REST)ful APIs that allow the application container to read/write to the IoT device database. Additionally, user and application API documentation may be maintained in the application container. Further still, a developer would configure an application firewall, where application metadata can specify outbound firewall configurations that allow the application container to establish a connection to a user's business application in the cloud or on-premises. User API permissions may also be defined by a developer via application metadata that specifies required API permissions. Such API permissions ensures that IoT applications are only able to access IoT device data that is relevant to the IoT application. In this way, IoT applications are prevented from affecting other IoT device data.

Moreover, a user would define/configure aspects of the AP which is operatively connected to the IoT connector. For example, a USB access control descriptor would be configured/defined to allow the IoT application to enable new types of USB devices, and for an AP to recognize and classify a user's USB device properly. Such a descriptor can be part of an IoT application's metadata, where the IoT application can install the descriptor on an AP's USB port turning it into an Ethernet interface. A user would also configure a USB serial data framing Lua script, where data from a USB serial type device can be framed by a Lua script in the user's IoT application so that the framed data can be tunneled to the IoT connector. IoT radio firmware can also be configured to allow different firmware to run on an AP's IoT-related radio(s). For example, if a user's IoT device uses a proprietary radio protocol, the user would develop firmware for that IoT-related radio. IoT data from the AP's IoT-related radio can be tunneled to the user's business application backend.

Thus, to develop an IoT application, a user would write the relevant Lua scripts as described above, and in the ADP, provide relevant information, such as application features/details, any application subscriptions (specifying which, e.g., BLE packets the Lua script can receive), device class permissions scripts for selecting which device classes the Lua script can write to the IoT device database, and device class classifications for selecting which device classes the IoT application can classify. Then, a draft of the application can be saved, installed on the IoT connector, and the end-to-end workflows can be tested. Once tested, the IoT application can be submitted for review. As can be appreciated, building an IoT application can be complex, as is the workflow associated with building/uploading an IoT application to application store 208. The ADP can provide a UI-based workflow where an app developer enters details of an application, such as device metadata, classifier script, container application binaries, resource requirements, and firewall permissions. All of this information can reside in a database, and is presented to a customer/network user in an application store format. This workflow requires the app developer to be well-versed in the different terminologies in the ADP context to obtain an approved app on the app store. Even then, if there are problems or issues in the Lua script or docker container, there is currently no form of validation for the business logic container therein. Examples of the disclosed technology can address this issue of the context of Lua scripts by having Lua validation as part of the Lua script generation process.

It should be understood that application store 208 can be a platform where entities or users (e.g., customers) of the NMS can browse through IoT applications that can be installed to enable different IoT functionalities. Application store 208 can be implemented as a collection of frontend and backend microservices. The frontend microservices handle the customer interactions, interpreting the user's requirements to deploy applications into actionable configurations/application software for installation on the network infrastructure. The backend microservices can interact with the proprietary IoT application information gathered via the ADP. The application information can be stored/managed via marketplace software, e.g., OpenChannel Angular.

An application recommendation service 208B can be provided as part of application store 208 for providing recommendations to users regarding existing applications maintained in application database 208A. That is, if a user is in need of an IoT device classification application to classify IoT devices in the user's IoT deployment, instead of developing the IoT device classification application from scratch, one or more appropriate IoT device classification applications in application store 208 may already exist. In this way, the user can leverage existing IoT applications to save time and resources.

Application recommendation service 208B can be implemented through machine learning, e.g., an unsupervised ML model. The ML model's underlying algorithm can retrieve statistics and relevant data from application store 208/application database 208A. That is, the underlying algorithm can obtain information regarding, e.g., historical application access/usage statistics, application performance data, user feedback, application features, previous user queries/searches that led to the selection of particular applications, and the like. The underlying algorithm may also collect information regarding existing user devices, e.g., IoT devices, that have already been classified. This collected information can comprise, but is not limited to, device type, device class, and vendor information. In some examples, the underlying algorithm can consider a complete history of IoT device-specific datasets that are available via the NMS ((e.g., NMS 104 of FIG. 1) hosting application store 208, in this example, for classifying commonly seen IoT devices.

Thereafter, the operationalized ML model can be run to learn those existing applications (stored in application database 208A and made available via application store 208) that are responsible for/capable of, e.g., classifying a set of devices, performed edge compute, etc. Following the device classification example, application recommendation service 208B may recommend one or more existing IoT device classification applications that the user can apply to classify its yet-unclassified IoT devices.

In some examples of the disclosed technology, application recommendation service 208B may filter out certain applications or limit the number of applications that are recommended to a user, e.g., five applications. This filtering/limiting of recommendations can be performed to further save time/resources by providing those applications that may be most applicable, or that may be optimal for a user's particular IoT devices/IoT deployment, etc. Additionally, application recommendation service 208B may sort the recommended applications based on various characteristics/metrics. For example, the ML model may output to a user, a set of recommended applications that are sorted by the number of IoT devices that can be classified, application installation counts, user ratings, and popularity. It should be noted that the metrics/characteristics themselves can be sorted by the underlying algorithm so that the ML model can prioritize those metrics/characteristics that are most relevant or impactful to the user and the user's IoT deployment.

As illustrated in FIG. 2A, and as noted above, IoT operations system 206 may further comprise an application development portal, e.g., ADP 210. ADP 210 may itself, comprise a chatbot 212. As also noted above, users may experience difficulties generating code, e.g., due to the use of Lua script, the application development workflow, the complexity of/considerations that go into an IoT application, etc. Accordingly, examples of the disclosed technology provide chatbot 212 which can be used to “converse” with the user to determine what IoT application(s) the user wishes to develop via, e.g., a Q and A interaction. By virtue of this Q and A interaction with chatbot 212, application development portal 210 can rely on code generation functionality of an LLM to automatically generate the appropriate Lua script that achieves the desired IoT application functionality, e.g., edge computing, IoT device classification, etc. It should be noted that a user need not necessarily engage in a Q and A session with chatbot 212. That is, if a user has the requisite information/data that would have been gleaned by virtue of conducting a Q and A session, and the user provides that information/data to chatbot 212, an appropriate application can be developed.

FIG. 2B illustrates an example of such a Q and A/code auto-generation session 300 that can be conducted/performed by chatbot 212 of FIG. 2B. As illustrated in FIG. 2B, a user interface (in this example, a graphical/textual user interface) can be used by user to interact with chatbot 212. A user (“Me”) can request that chatbot 212 write a Lua device classification script that can be used to classify all devices in the user's deployment that are manufactured by or that come from a particular company (“ACME”). Chatbot 212 may generate a Lua script that can perform such a classification operation. It should be understood that the example is simplified for ease of illustration/explanation. That is, chatbot 212 and a user may engage in further Q and A to exchange needed information/data/parameters appropriate for generating the desired Lua script. Chatbot 212, upon gleaning the needed information/data/parameters from a user, can generate the Lua script 224. Chatbot 212 may further provide insights/tips/additional information that may be needed, in this example, a note that the resulting auto-generated Lua script embodying the desired device classification application should subscribe to vendor match types “4C00.”

Chatbot 212, in accordance with examples of the disclosed technology, can leverage anNLTK, an LLM, and a code generator whose supervised learning functionality can be fine-tuned based on NMS-specific information, such as existing IoT application in the application store, examples of code from “official” Lua language documentation, and IoT Operations user documents present/maintained in IoT Operations system 206. Lua scripts/applications that already exist in application store 208 can follow similar workflows of populating global device context data, if-else blocks/statements to check whether a device can be classified, etc. As such, the existing Lua scripts/applications can make for an effective training dataset due to the existence of common code patterns.

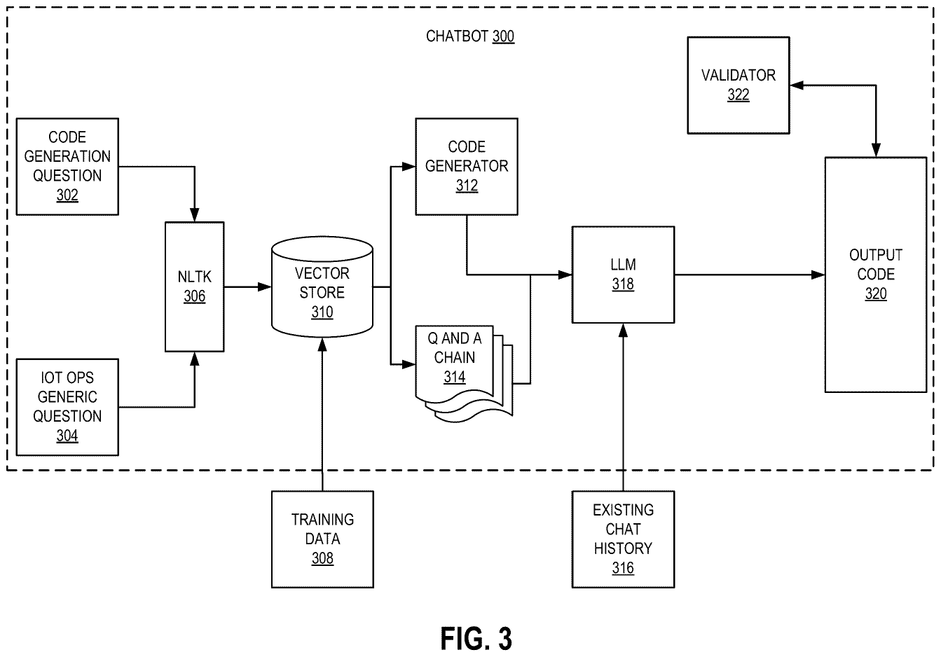

FIG. 3 illustrates a more detailed representation of a chatbot 300 (which may be an embodiment of chatbot 212 of FIG. 2). An NLTK, e.g., NLTK 306, may tokenize user-provided or input plain text into smaller parts for easier machine analysis. The user-provided plain text can come from one or more code generation questions 302 (e.g., a user asking chatbot 300) to write a Lua script enabling the classification of devices), as well as an IoT operations generic question (e.g., clarification questions regarding what specific UI components of an ADP workflow mean, what default values may be, which Lua APIs may be used to set desired device attributes, etc.). In general, generic IoT operations questions can comprise non-code-generation-specific inquiries made by a user IoT operations.

A similarity search can be conducted by the chatbot at a vector store 310 to look for code blocks or statements or portions of code that are the same as or are similar to the various tokens generated by NLTK 306 as a result of breaking down (tokenizing) one or both of code generation questions 302 and IoT operations generic questions 304. Vector store 310 can refer to a database or repository that facilitates the storage and searching of unstructured data by embedding the unstructured data (converting unstructured data into a numerical array that expresses the data's original meaning) and storing the resulting embedding vectors (unique fingerprints for a piece of data). The similarity search can entail embedding an unstructured query and retrieving those embedding vectors that are most similar to the embedded query. In accordance with examples of the disclosed technology, NLTK 306 can tokenize the plain text to identify specific keywords (e.g., vendor identifiers, device classes, service data, and device-specific contextual data).

In accordance with examples of the disclosed technology, training data 308 can be used to populate vector store 310. Training data 308 can comprise known/open source (publicly available) Lua training data, and in addition, to facilitate the aforementioned fine tuning, proprietary data of the NMS (e.g., NMS IoT data/deployment data, data gathered across multiple users supported by the NMS, and so on). This fine tuning can enrich the known/typical training data in accordance with examples of the disclosed technology. A framework (or platform) such as LangChain can be used to ingest and break down training data 308 for storage in vector store 310, and to create Q and A chains 314, which can be powered by LLM 318. Existing chat history 316 can also be used to fine tune the Q and A chain 314 powered by LLM 318. That is, all or some plain text inputs entered into the chatbot can be broken down into vectors, which in turn, can provide additional data for LLM 318, which can act as chat history.

Code generator 312 can be built on top of LLM 318, and can be trained in a similar manner, but with more specialized, code generation-geared training data. Such training data can include Lua scripts written by users familiar with the language, users associated with the NMS or provider of the IoT operations system, which can also be stored as part of training data 308 (or separately in a dedicated data store).

LLM 318 can be trained and fine-tuned based on vectors from Q and A chains 314, where a current (user) input, e.g., a question, can be answered by LLM 318 via the output generated from the current input run across a similarity search through vector store 310.

Ultimately, chatbot 300 can provide or facilitate a question and answer session (Q and A chain 314) with a user that results in “final” output code 320, i.e., Lua script representative of an IoT application. In some examples, users can manipulate payload bytes using NLTK 306 (e.g., type conversions, pattern matching, etc.) in order to assign parsed values to, e.g., a Lua device decoder API. In this way, the burden on the user is lessened versus the user having to write an application. In addition to the Lua script/code 320B itself, any metadata needed for application submission to the ADP, e.g., ADP 210, is provided by chatbot 300, where the Lua script/code 320 can be uploaded to the ADP and the metadata can be populated using IoT operations-specific APIs. Any broader or more generic questions from a user regarding IoT operations can also be provided by the chatbot.

It should be noted that once output code 320 has been generated, validation is performed to ensure that the automatically-generated code/script will operate or perform as desired and as expected. Accordingly, examples of the disclosed technology also implement a validator to check the code/script generated by the chatbot. Using BLE device classification as a contextual example, a validator 322 comprises a collection of Lua scripts packaged together to execute the functionality written into the Lua scripts using data from BLE packets that the user can provide. Validator 322 may allow the user to set variable values using APIs in the script so it can compare expected values with actual values from the BLE packets.

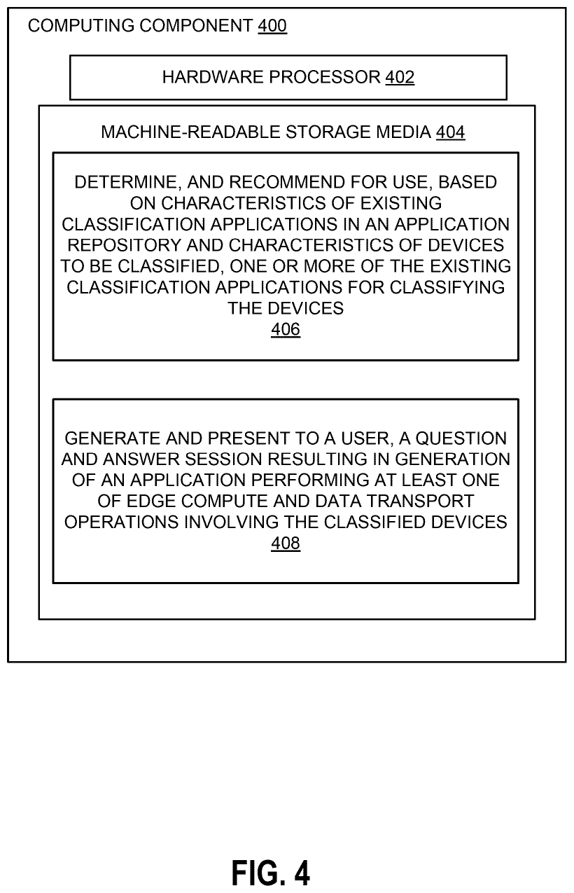

FIG. 4 illustrates a computing component 400 that may be used to implement automated code generation in accordance with various examples of the disclosed technology. Referring now to FIG. 4, computing component 400 may be, for example, a server computer, a controller, or any other similar computing component capable of processing data. In the example implementation of FIG. 4, the computing component 400 includes a hardware processor 402, and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-408, to automatically generate IoT application code. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-408.

Hardware processor 402 may execute instruction 406 to determine, and recommend for use, based on characteristics of existing classification applications in an application repository and characteristics of devices to be classified, one or more of the existing classification applications for classifying the devices. As discussed above, in an IoT context, IoT device classification is typically needed in order to identify a user's IoT devices of interest-those IoT devices in a user's deployment that may be the target or subject of an IoT application that is developed to support a user's IoT use case. In some examples, an application store can be implemented that maintains existing IoT applications, one or more of which may be recommended to the user for classifying its IoT devices if any of its IoT devices still require classification. This application store can be implemented using an unsupervised ML model that can retrieve statistics and other relevant data regarding already-existing applications in the application store to understand their popularity, history of use/features, performance, etc. Similarly, information about already-classified IoT devices can be collected. This information can be used to determine with the ML model what applications may be appropriate for classifying IoT devices, and can recommend one or more of these applications to the user.

Hardware processor 402 may execute instruction 408 to generate and present to a user, a question and answer session resulting in generation of an application performing at least one of edge compute and data transport operations involving the classified devices. Once classified, a user typically will want to develop some IoT application for data transport to/from its IoT devices, or to effectuate some form of edge computations. As described above, without the benefit of a generative AI chatbot that can guide/respond to a user's requests/queries, the user would have to understand a preferred programming language, APIs, metadata, application uploading and validation workflows, and so on. However, in accordance with examples of the disclosed technology, user input(s), e.g., user questions, can be run through a vector store where a similarity search can be performed allowing an LLM to generate an answer(s). If the answer is generated code, that generated code can be validated by a validator component.

In accordance with examples of the disclosed technology, rather than a user needing to break down vendor-specific information about devices they wish to classify, a chatbot can prompt users with the questions needed to generate an appropriate application. The chatbot can automatically run the generated script through a validator that can perform static analysis of the script, and demonstrate a sample device payload processed by the script and corresponding parsed output data. The result is an application which is guaranteed to work out of the box developed in a few minutes with the heavy lifting performed by the disclosed technology.

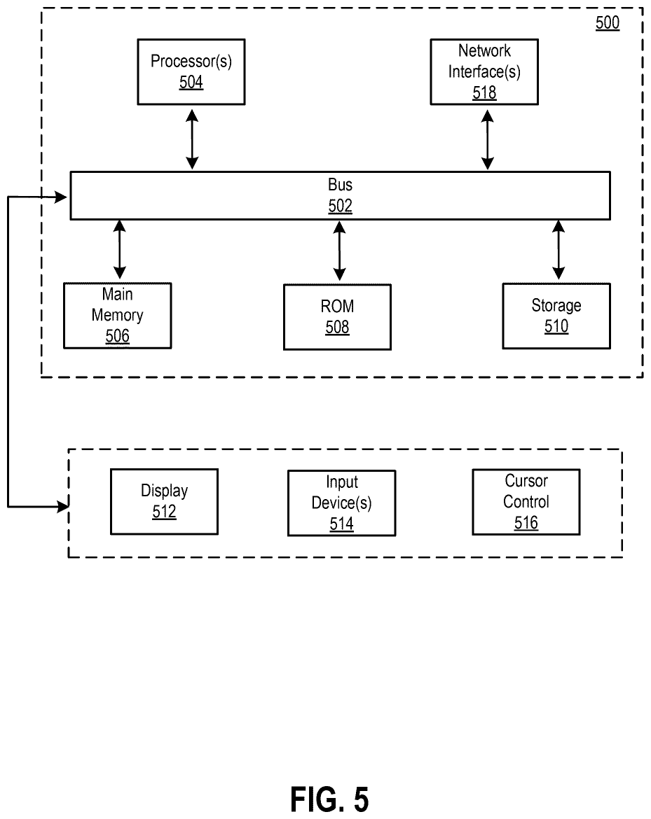

FIG. 5 depicts a block diagram of an example computer system 500 in which various examples of the disclosed technology described herein may be implemented. Elements of network 102, e.g., IoT operations system 106, or its component parts, e.g., application store 208, application recommendation service 208B, application development portal 210, chatbot 212, etc. may be embodiments of computer system 500. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some examples, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one example of the disclosed technology, the techniques herein are performed by computer system 500 in response to processor(s) 504 executing one or more sequences of one or more instructions contained in main memory 506.

The term “non-transitory media,” and similar terms, as used herein refers to any media that store data and/or instructions that cause a machine to operate in a specific fashion. Such non-transitory media may comprise non-volatile media and/or volatile media. Non-transitory media is distinct from but may be used in conjunction with transmission media. Transmission media participates in transferring information between non-transitory media.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. The signals through the various networks and the signals on network link and through communication interface 518, which carry the digital data to and from computer system 500, are example forms of transmission media.

The computer system 500 can send messages and receive data, including program code, through the network(s), network link and communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a processor; and
a memory unit storing instructions that when executed, cause the processor to:
determine, and recommend for use, based on characteristics of existing classification applications in an application repository and characteristics of devices to be classified, one or more of the existing classification applications for classifying the devices;
generate and present to a user, a question and answer session resulting in generation of an application performing at least one of edge compute and data transport operations involving the classified devices.

2. The system of claim 1, wherein the resulting application comprises executable script in a system-specific coding language.

3. The system of claim 2, wherein the memory includes instructions that when executed, further cause the processor to upload the executable script to the application repository.

4. The system of claim 3, wherein the memory includes instructions that when executed, further cause the processor to populate metadata associated with the resulting application with one or more system-specific application programming interfaces (APIs).

5. The system of claim 1, wherein the memory unit stores further instructions comprising a machine learning (ML) model that causes the processor to retrieve the characteristics of existing classification applications.

6. The system of claim 5, wherein the characteristics comprise at least one of statistical data and application-usage relevant data regarding the existing classification applications from the application repository.

7. The system of claim 1, wherein the instructions that when executed cause the processor to generate and present to the user, the question and answer session, further cause the processor to input to a vector store, a current question of the question and answer session.

8. The system of claim 7, wherein the instructions that when executed cause the processor to generate and present to the user, the question and answer session, further cause the processor to execute a similarity search based on the current question.

9. The system of claim 8, wherein the memory unit stores further instructions comprising a large language model, the large language model outputting script making up the generated application.

10. The system of claim 1, wherein the memory unit stores further instructions that when executed further causes the processor to validate the generated application.

11. A system, comprising:
a natural language toolkit tokenizing plaintext provided by a user regarding Internet of Things (IoT) device-related automated application generation;
a vector store performing a similarity search to identify portions of code that are the same as or similar to tokens generated by the natural language toolkit and representative of the user-provided plaintext; and
a large language model generating and conducting a question and answer session with the user based on the performance of the similarity search; and
a code generator automatically generating an IoT device-related application based on the question and answer session.

12. The system of claim 11, wherein the user-provided plaintext originates from at least one of one or more code generation questions provided by a user and Internet of Things (IoT) operations questions.

13. The system of claim 11, wherein the tokens identify specific keywords regarding IoT device-relevant characteristics.

14. The system of claim 11, wherein the vector store embeds the tokens, and stores resulting embedding vectors associated with the tokens.

15. The system of claim 11, wherein the vector store is trained using at least one of known scripts, network management proprietary data regarding a deployment in which the IoT device is operating, network management proprietary data regarding a plurality of IoT device users.

16. The system of claim 11, wherein the question and answer session is fine-tuned using historical question and answer session information.

17. The system of claim 11, further comprising a validator validating the automatically generated IoT device-related application.

18. A chatbot, comprising:
a processor; and
a memory unit storing instructions that when executed, cause the processor to:
conduct a question and answer session with a user seeking to develop an IoT device-related application;
tokenize plaintext questions obtained the user during the question and answer session, and store resulting tokens representative of keywords regarding IoT device-relevant characteristics;
perform a similarity search to identify portions of known IoT device-related application code that are same as or similar to the resulting tokens; and
automatically generate code representative of the IoT device-related application.

19. The chatbot of claim 18, wherein the question and answer session is refined by a large language model trained on existing chat history.

20. The chatbot of claim 18, wherein the memory unit stores further instructions that when executed cause the processor to validate the automatically generated code based on user-provided data regarding an IoT device, executing a collection of existing code packaged together to execute functionality written into the automatically generated code, and comparing expected output of the collection of existing code and the automatically generated code.
